(19) United States
(12) Patent Application Publication
(10) Pub. No.: US 2025/0252036 A1
(43) Pub. Date: Aug. 7, 2025

(54) CLUSTER-BASED AUTOMATED IDENTIFICATION OF SOFTWARE APPLICATION TEST CASES FOR TESTING MICROSERVICES

(71) Applicant: Dell Products L.P., Round Rock, TX (US)

(72) Inventors: Efi Levi, Beer Sheba (IL); Israel Truman, Meitar (IL); Lior Benisty, Beer Sheva (IL)

(21) Appl. No.: 18/434,069

(22) Filed: Feb. 6, 2024

(51) Int. Cl. G06F 11/36

(52) U.S. Cl. CPC G06F 11/3688; G06F 11/3676

(57) ABSTRACT

Techniques are provided for cluster-based automated identification of software application test cases for testing microservices. One method comprises, in response to a modification of software code of a given microservice of multiple microservices of an application: identifying, from multiple clusters of microservices, one or more clusters each comprising the given microservice; for one or more microservices in the identified clusters, identifying, using information characterizing microservices tested by each test case, test cases that test the respective microservice in the identified clusters; and initiating an execution of the identified test cases that test the one or more microservices in the identified clusters. The clusters of microservices may be generated using a feature vector representation of the endpoints associated with each microservice. Test cases associated with a first cluster may be performed in parallel with test cases associated with a second cluster that does not overlap with the first cluster.

### BACKGROUND

A software application is often comprised of multiple microservices. It is often necessary to evaluate a software application following a modification of the software application. Conventional approaches for testing the software application following such a modification, however, typically execute all tests in a test suite associated with the software application in order to determine whether any functionality of the software application has been impaired by the modification.

### SUMMARY

Illustrative embodiments of the disclosure provide techniques for cluster-based automated identification of software application test cases for testing microservices. An exemplary method comprises performing, in response to a modification of software code of a given microservice of a plurality of microservices of at least one application: identifying, from a plurality of clusters of microservices, one or more clusters each comprising the given microservice; for one or more microservices in the identified one or more clusters, identifying, using information characterizing one or more microservices tested by one or more test cases of a plurality of test cases, one or more test cases that test the respective microservice in the identified one or more clusters; and automatically initiating an execution of the identified one or more test cases that test the one or more microservices in the identified one or more clusters.

Illustrative embodiments can provide significant advantages relative to conventional microservice testing techniques. For example, problems associated with existing microservice testing techniques are overcome in one or more embodiments by using a cluster-based approach to automatically identify one or more test cases to execute in order to test one or more microservices of a software application that are impacted by a modification of a given microservice of the software application.

These and other illustrative embodiments include, without limitation, methods, apparatus, networks, systems and processor-readable storage media.

### BRIEF DESCRIPTION OF THE DRAWINGS

FIG. 1 illustrates an information processing system configured for cluster-based automated identification of software application test cases for testing microservices in an illustrative embodiment;

FIG. 2 illustrates a microservices testing manager in an illustrative embodiment;

FIG. 3 is a flow chart illustrating an exemplary implementation of a process for test coverage analysis in an illustrative embodiment;

FIG. 4 is a flow chart illustrating an exemplary implementation of a process for microservices endpoint analysis in an illustrative embodiment;

FIG. 5 is a flow chart illustrating an exemplary implementation of a process for clustering microservices in an illustrative embodiment;

FIG. 6 is a flow chart illustrating an exemplary implementation of a process for cluster identification in an illustrative embodiment;

FIG. 7 illustrates a set of microservice clusters in an illustrative embodiment;

FIG. 8 is a flow chart illustrating an exemplary implementation of a process for cluster-based automated identification of software application test cases for testing microservices in am illustrative embodiment;

FIG. 9 illustrates an exemplary processing platform that may be used to implement at least a portion of one or more embodiments of the disclosure comprising a cloud infrastructure; and

FIG. 10 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for cluster-based automated identification of software application test cases for testing microservices.

In a microservices architecture, end-to-end testing plays an important role in ensuring the reliability and functionality of a given application. Such tests are designed to comprehensively assess the full scope of the application, for example, typically spanning from a user interface to one or more underlying databases. For example, following a modification of source code of a given microservice, it is often important to determine whether the modification affects other microservice of the given application. Due to the distributed nature of microservices, however, conducting such tests presents a number of challenges.

A microservices architecture often involves multiple layers of functionality distributed across various services. Thus, a substantial number of test cases often need to be executed to validate the behavior of the given application. The complexity of such tests is amplified by the interactions between diverse user interactions and backend systems, often contributing to prolonged test execution times.

To mitigate the time required to perform such testing, parallel execution becomes an attractive option. By running multiple tests concurrently, the overall testing process can be expedited. Implementing parallel execution of such tests in a microservices environment, however, presents additional challenges. Achieving parallelism requires orchestrating multiple instances of the application to operate simultaneously, for example, each with its own test data and testing environment.

One or more embodiments of the disclosure provide techniques for cluster-based automated identification of software application test cases for testing microservices. In some embodiments, the automated test case identification techniques execute only the test cases that are affected by a modification of the source code of a given microservice of an application. One or more clusters of microservices that are directly or indirectly affected by the modification are identified, as well as the test cases that should be executed for the identified clusters (e.g., there is no need to execute test cases for clusters that are not affected by the modification). In addition, when there are multiple clusters affected by the modification, test cases that can be executed in parallel may be identified. In this manner, testing time and resource utilization are improved.

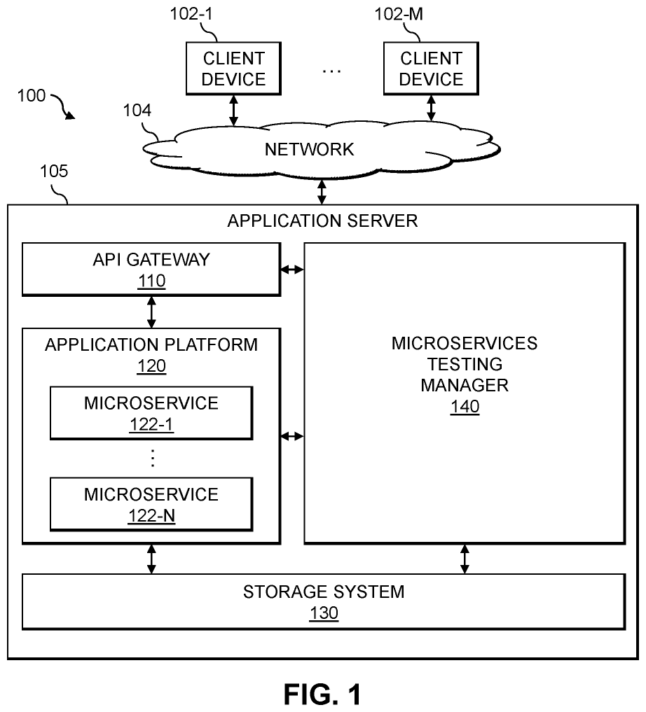

FIG. 1 shows an information processing system 100 configured for cluster-based automated identification of software application test cases for testing microservices in an illustrative embodiment. The information processing system 100 comprises client devices 102-1, . . . 102-M (collectively “client devices 102”), a network 104, and an application server 105.

The client devices 102 can comprise, for example, Internet of Things (IoT) devices, desktop, laptop or tablet computers, mobile telephones, or other types of processing devices capable of communicating with the application server 105 over the network 104. Such devices are examples of what are more generally referred to herein as “processing devices.” Some of these processing devices are also generally referred to herein as “computers.” It is also to be appreciated that the term “client device” is intended to be broadly construed so as to also encompass, for example, a calling application and/or a calling service that is connected on a network (e.g., network 104). Also, it is to be understood that a given one of the client devices 102 can encompass a computer, where a user accesses or interacts with a calling application even if the calling application is not on the computer (e.g., the calling application could be on one or more computing platforms, including the same one that a requested microservice is executed on).

The client devices 102 may comprise respective computers associated with a particular company, organization or other enterprise. In addition, at least portions of the information processing system 100 may also be referred to herein as collectively comprising an “enterprise network.” Numerous other operating scenarios involving a wide variety of different types and arrangements of processing devices and networks are possible, as will be appreciated by those skilled in the art.

It is to be appreciated that the terms “client” and “user” as described herein are intended to be broadly construed so as to encompass numerous arrangements of human, hardware, software or firmware entities, as well as combinations of such entities.

The client devices 102 can access the application server 105 over the network 104. The network 104 is assumed to comprise a portion of a global computer network such as the Internet, although other types of networks can be part of the information processing system 100, including a wide area network (WAN), a local area network (LAN), a satellite network, a telephone or cable network, a cellular network, a wireless network such as a Wi-Fi or WiMAX network, or various portions or combinations of these and other types of networks. The information processing system 100 in some embodiments therefore comprises combinations of multiple different types of networks, each comprising processing devices configured to communicate using internet protocol (IP) or other related communication protocols.

The application server 105 in the FIG. 1 embodiment is assumed to be implemented using at least one processing device. Each such processing device generally comprises at least one processor and an associated memory, and implements one or more functional modules for controlling certain features of the application server 105.

More particularly, the application server 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the application server 105 to communicate over the network 104 with the client devices 102, and illustratively comprises one or more conventional transceivers.

In the FIG. 1 example, the application server 105 further comprises an API (application programming interface) gateway 110, an application platform 120, a storage system 130, and a microservices testing manager 140. The application server 105 is configured to perform data processing, data storage, and data management functions to support one or more cloud-based or web-based applications or services and/or other types of applications that are implemented by the application platform 120. It is to be appreciated that at least a portion of the available services and functionalities provided by the application server 105 in some embodiments may be provided under Function-as-a-Service (“FaaS”), Storage-as-a-Service (“STaaS”), Containers-as-a-Service (“CaaS”) and/or Platform-as-a-Service (“PaaS”) models, including cloud-based FaaS, StaaS, CaaS and PaaS environments.

The application platform 120 of the application server 105 is assumed to implement at least a portion of a microservice architecture which includes a plurality of microservices 122-1, . . . 122-N(collectively, microservices 122) that are combined to provide a structured application. For example, the microservice architecture may implement an application as a collection of loosely-coupled services, wherein the services expose fine-grained APIs and lightweight protocols. Each microservice 122 can include a self-contained software module with associated functionality and interfaces. In some embodiments, the application platform 120 runs in a virtualized environment (e.g., virtual machines) or a containerized environment (e.g., containers) in which the number of instances of a given microservice and the locations (e.g., host and port) of such instances change dynamically.

In the microservices architecture of FIG. 1, each microservice 122 (and instances thereof) may expose a set of fine-grained endpoints to access resources provided by the microservice. Each endpoint specifies a location from which APIs can access the resources needed to perform functions. Each microservice 122 can maintain its own database in the storage system 130 in order to be decoupled from other microservices. The microservice-based framework enables the individual microservices 122 to be deployed and scaled independently, to be developed and updated in parallel by different teams and in different programming languages, and to have their own continuous delivery and deployment stream. While the application platform 120 is generically depicted in FIG. 1, the application platform 120 can implement any suitable cloud-based application (e.g., a multi-tenant SaaS (software-as-a-service) application). For example, the application platform 120 can implement a cloud-based SaaS application that allows customers to monitor, analyze, and troubleshoot their storage systems, or any other type of SaaS application which comprises hundreds or thousands of microservices and associated endpoints.

The storage system 130, in at least some embodiments, can be implemented using any of a variety of different types of storage including network-attached storage (NAS), storage area networks (SANs), direct-attached storage (DAS) and distributed DAS, as well as combinations of these and other storage types, including software-defined storage. For example, the storage system 130 can include a plurality of storage nodes comprising storage appliances with memory controllers, processors, cache memory, and non-volatile storage media to provide persistent storage resources (e.g., file repositories, databases, etc.) for the application platform 120 and/or other components or systems associated with the application server 105.

The API gateway 110 implements methods that are configured to enable client applications to access the services of the application platform 120. In particular, the API gateway 110 provides a single-entry point for client applications to issue API requests for services that are provided by the application platform 120. The API gateway 110 abstracts the client applications from knowing how the application platform 120 is partitioned into microservices, and from having to determine the locations of service instances. The API gateway 110 comprises logic for calling one or more of the microservices 122 in response to a client request. The API gateway 110 communicates with client applications and the microservices 122 using any suitable API framework. For example, in some embodiments, the API gateway 110 and the microservices 122 implement a REST (Representational State Transfer) API. In other embodiments, the API gateway 110 and the microservices 122 implement a SOAP (Simple Object Access Protocol) API.

In at least some embodiments, a login portal can be associated with the API gateway 110 to allow client applications running on client devices (e.g., client devices 102) to access the individual microservices 122 of the application platform 120. In such an example, the login portal can include a user interface which implements methods that allow a user to connect to the application server 105 (via a client device 102) and log in to the application server 105 and provide credentials for a user authentication/verification process. In some embodiments, the login portal comprises different user interfaces to support connectivity with different types of devices (for example, mobile devices, desktop computers, servers, etc.) and different types of HTML-based browsers.

In some embodiments, the API gateway 110 is implemented using a single gateway service that is configured to interface with many different types of client applications (e.g., web-based applications, mobile applications, etc.). In other embodiments, the API gateway 110 comprises a plurality of gateway services, each configured to interface with a different type of client application. In all instances, the API gateway 110 performs various functions. For example, the API gateway 110 functions as a reverse proxy to redirect or route requests from client applications to target endpoints of the microservices 122. In this instance, the API gateway 110 provides a single endpoint or Uniform Resource Locator (URL) to receive requests from client applications for access to services of the application platform 120, and internally maps client requests to one or more of the microservices 122.

Furthermore, the API gateway 110 can implement aggregation services to aggregate multiple client requests (e.g., HTTP requests) which target multiple microservices 122 into a single request. In this instance, a client application may send a single request to the API gateway 110 to perform a single task, and the API gateway 110 dispatches multiple calls to different backend microservices 122 to execute the task. The API gateway 110 aggregates the results from the multiple microservices and sends the aggregated results to the client application. In this instance, the client application issues a single request and receives a single response from the API gateway 110 despite the single request being parsed and processed by multiple microservices 122. The API gateway 110 can be configured to implement other functions or microservices to implement authentication and authorization, service discovery, response caching, load balancing, etc.

It is to be appreciated that this particular arrangement of API gateway 110, the application platform 120, the storage system 130 and the microservices testing manager 140 in the application server 105 of the FIG. 1 embodiment is presented by way of example only, and alternative arrangements can be used in other embodiments. For example, the functionality associated with the elements 110, 120, 130 and/or 140, or portions thereof, in other embodiments can be combined into a single module, or separated across a larger number of modules. As another example, multiple distinct processors can be used to implement different ones of the elements 110, 120, 130 and/or 140 or portions thereof.

At least portions of elements 110, 120, 130 and/or 140 may be implemented at least in part in the form of software that is stored in memory and executed by a processor.

It is to be understood that the particular set of elements shown in FIG. 1 for application server 105 involving client devices 102 of information processing system 100 is presented by way of illustrative example only, and in other embodiments additional or alternative elements may be used. Thus, another embodiment includes additional or alternative systems, devices and other network entities, as well as different arrangements of modules and other components. As a non-limiting example, in at least one embodiment, the API gateway 110, the application platform 120, the storage system 130 and/or the microservices testing manager 140 may be implemented on one or more other processing platforms that are accessible to the application server 105 over one or more networks. Such components can each be implemented at least in part within another system element or at least in part utilizing one or more stand-alone components coupled to the network 104.

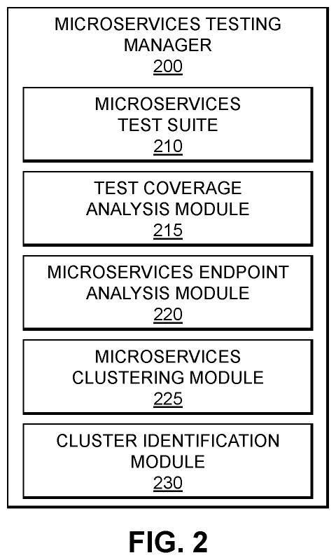

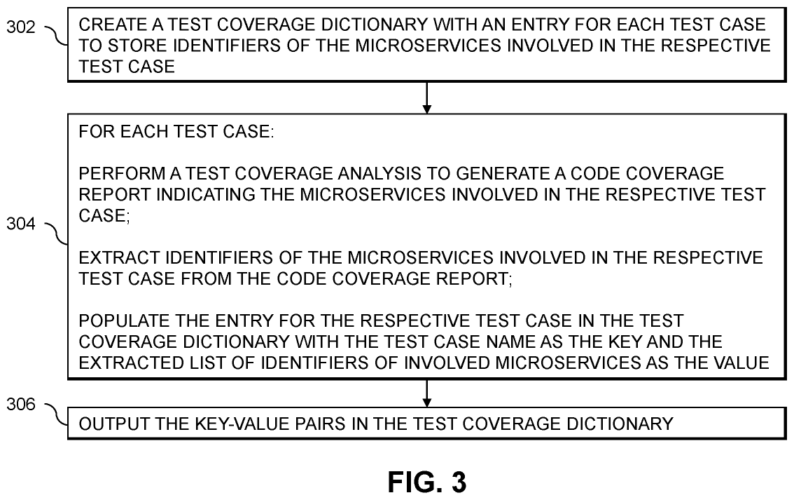

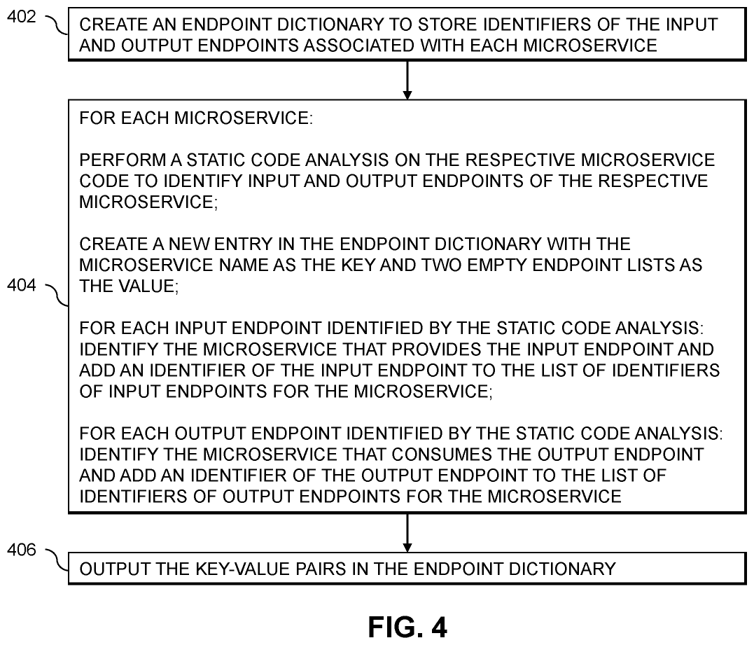

FIG. 2 illustrates a microservices testing manager 200 in an illustrative embodiment. In the example of FIG. 2, the microservices testing manager 200 comprises a microservices test suite 210, a test coverage analysis module 215, a microservices endpoint analysis module 220, a microservices clustering module 225 and a cluster identification module 230. In one or more embodiments, the microservices test suite 210 comprises a plurality of test cases and/or test scripts for testing one or more microservices. The test coverage analysis module 215, in some embodiments, evaluates a degree to which a given software system has been evaluated by the microservices test suite 210, as discussed further below in conjunction with FIG. 3. The microservices endpoint analysis module 220 may analyze one or more input and output endpoints of each microservice in a microservices architecture, for example, to identify one or more dependencies and/or interactions between different microservices, as discussed further below in conjunction with FIG. 4.

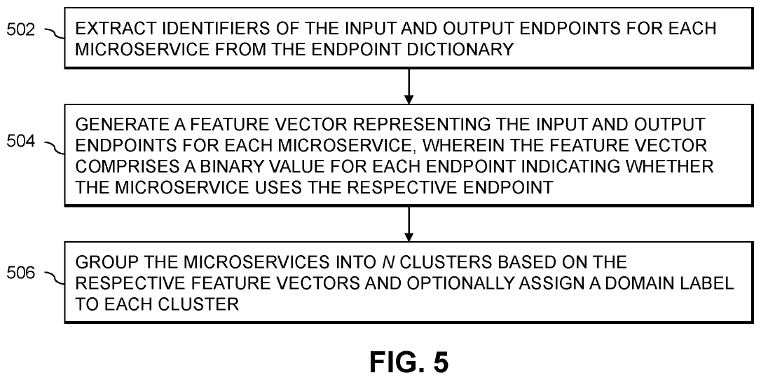

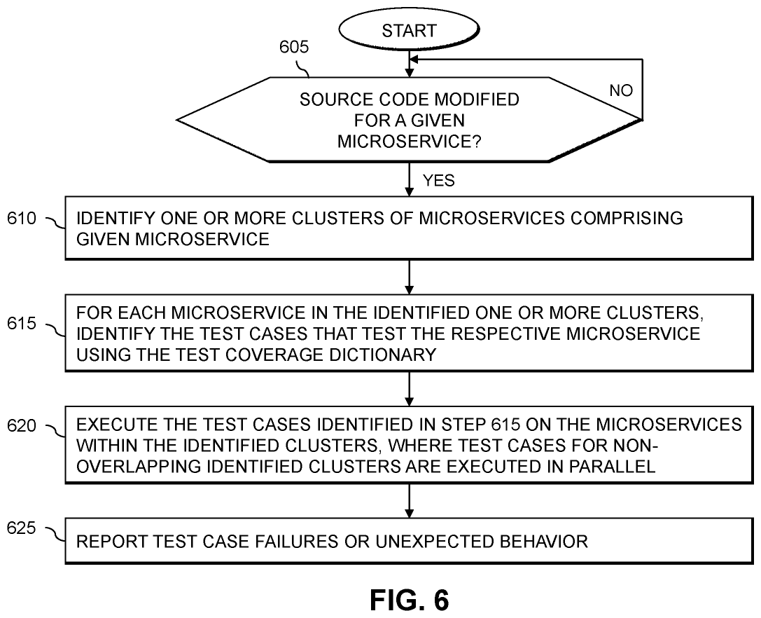

In at least some embodiments, the microservices clustering module 225 groups microservices of a given software system into clusters based on the respective input and output endpoints of each microservice, as discussed further below in conjunction with FIG. 5. The cluster identification module 230, following a modification of source code of a given microservice, identifies one or more clusters comprising the given microservice, as discussed further below in conjunction with FIG. 6.

FIG. 3 is a flow chart illustrating an exemplary implementation of a process for test coverage analysis in an illustrative embodiment. The process of FIG. 3 may be implemented, for example, by the test coverage analysis module 215 of FIG. 2 to evaluate a degree to which a given software system has been evaluated by the microservices test suite 210. A code coverage tool may be employed to record the microservices involved in each test case. As discussed hereinafter, the results may be stored in a dictionary that uses the test case names as keys with a list of the microservices involved in the respective test case as values.

In the example of FIG. 3, a test coverage dictionary (or another data structure in other embodiments) is created in step 302 with an entry for each test case to store identifiers of the microservices involved in the respective test case. In step 304, a loop is entered for each test case, where a test coverage analysis is performed to generate a code coverage report indicating the microservices involved in the respective test case; identifiers of the microservices involved in the respective test case are extracted from the code coverage report; and the entry for the respective test case is populated in the test coverage dictionary with the test case name as the key and the extracted list of identifiers of involved microservices as the value. The test coverage analysis of step 304 may be performed, for example, using a code coverage library available in Java. Once all test cases have been processed in step 304, the test coverage dictionary comprises the microservices involved in each test case. The key-value pairs in the test coverage dictionary may be output in step 306, where each key identifies a test case name and the corresponding value is a list of microservices involved in the test case.

FIG. 4 is a flow chart illustrating an exemplary implementation of a process for microservices endpoint analysis in an illustrative embodiment. The process of FIG. 4 may be implemented, for example, by the microservices endpoint analysis module 220 of FIG. 2 to analyze one or more input and/or output endpoints of each microservice in a microservices architecture. In this manner, one or more dependencies and/or interactions between different microservices may be identified, for example, to provide insights into the flow of data and information within the microservices architecture.

In the example of FIG. 4, an endpoint dictionary (or another data structure in other embodiments) is created in step 402 to store identifiers of the input and output endpoints associated with each microservice. For example, the input and output endpoints associated with each microservice may comprise REST APIs and/or message queues.

In step 404, a first loop is entered for each microservice, where a static code analysis is performed on the respective microservice code to identify one or more input and output endpoints of the respective microservice and a new entry is created in the endpoint dictionary with the microservice name as the key and two empty endpoint lists as the value. For example, a static code analysis tool may be employed in step 404 that inspects a code quality of each microservice using a static analysis of code to detect software bugs and other software code issues.

A second loop is performed within the first loop for each input endpoint identified by the static code analysis to identify the microservice that provides the input endpoint and add an identifier of the input endpoint to the list of identifiers of input endpoints for the microservice. In addition, a third loop is performed within the first loop for each output endpoint identified by the static code analysis to identify the microservice that consumes the output endpoint and add an identifier of the output endpoint to the list of identifiers of output endpoints for the microservice. The key-value pairs in the endpoint dictionary may be output in step 406, where each key identifies a microservice name and the corresponding value is a tuple comprising a first list of identifiers of input endpoints and second list of identifiers of output endpoints.

FIG. 5 is a flow chart illustrating an exemplary implementation of a process for clustering microservices in an illustrative embodiment. The process of FIG. 5 may be implemented, for example, by the microservices clustering module 225 of FIG. 2 to group microservices of a given software system based on respective input and output endpoints of each microservice. In some embodiments, the clustering process of FIG. 5 automates the grouping of microservices into domains, which may help to identify a given microservice and the microservices connected to the given microservice that need to be tested when a change is made to the given microservice.

In the example of FIG. 5, identifiers of the input and output endpoints for each microservice are extracted from the endpoint dictionary in step 502. In step 504, the process of FIG. 5 generates a feature vector representing the input and output endpoints for each microservice. The feature vector generated in step 504 may comprise, for example, a binary value for each endpoint indicating whether the microservice uses the respective endpoint. For example, if a given microservice uses two input endpoints E1 and E2 and one output endpoint E3, the feature vector for the given microservice may be expressed as [1, 1, 1, 0, 0, 0, . . . ], where the length of the vector is equal to the total number of endpoints in the system.

In step 506, the microservices are grouped into N clusters based on the respective feature vectors and a domain label may optionally be assigned to each cluster (for example, by a domain expert). A clustering algorithm, such as a K-means clustering algorithm or a DBSCAN (density-based spatial clustering of applications with noise) clustering algorithm may be employed, for example, in step 506. The number of generated clusters may be based, for example, on domain knowledge or by using elbow method techniques, as would be apparent to a person of ordinary skill in the art. The domain label may be assigned to each cluster, for example, based on a business function or a purpose of the microservices in the respective cluster.

FIG. 6 is a flow chart illustrating an exemplary implementation of a process for cluster identification in an illustrative embodiment. The process of FIG. 6 may be implemented, for example, by the cluster identification module 230 of FIG. 2, for example, following a modification of the source code of a given microservice, to identify one or more clusters comprising the given microservice. In some embodiments, the process of FIG. 6 automatically identifies one or more clusters of microservices impacted by a modification of a particular microservice and automatically executes the relevant test cases for the microservices in the identified clusters.

In the example of FIG. 6, a test is performed in step 605 to determine whether the source code has been modified for a given microservice. The source code modification may be the result of, for example, a bug fix, a feature enhancement or another code change requirement. If it is determined in step 605 that the source code has not been modified for a given microservice, then program control returns to step 605 to continue monitoring for a microservice code modification. If it is determined in step 605 that the source code has been modified for a given microservice, then one or more clusters of microservices comprising the given microservice are identified in step 610. For example, clusters may be identified based on one or more criteria such as shared input-output endpoints, dependencies or a logical grouping defined by the architecture (e.g., if microservice A and microservice B both interact with microservice C, then microservice A and microservice B might belong to the same cluster).

A loop is entered in step 615 for each microservice in the identified one or more clusters, to identify the test cases that test the respective microservice using the test coverage dictionary (or another data structure in other embodiments). In step 620, the process of FIG. 6 executes the test cases identified in step 615 on the microservices within the identified clusters, where test cases for non-overlapping identified clusters may be executed in parallel. For example, in scenarios where multiple clusters are identified, and they do not overlap (e.g., changes in one cluster do not directly affect another cluster), then the test cases for these clusters may be executed in parallel (thereby improving the testing time and resource utilization). The executed test cases aim to validate that the code changes made to the given microservice have not introduced regressions or other issues into other microservices and that the microservices continue to function as expected within their respective domains.

Any detected test case failures or unexpected behavior may be reported in step 625.

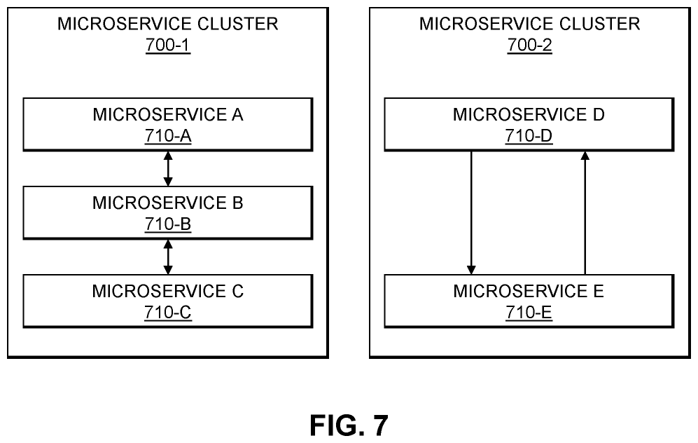

FIG. 7 illustrates a representative set of microservice clusters 700-1 and 700-2 comprising microservices 710-A through 710-E in an illustrative embodiment. The microservices 710-A through 710-E can be assigned to one or more clusters, for example, using the feature vector-based clustering process of FIG. 5. In the example of FIG. 7, microservice cluster 700-1 comprises microservices 710-A through 710-C and microservice cluster 700-2 comprises microservices 710-D and 710-E. Since microservice clusters 700-1 and 700-2 do not overlap (e.g., the microservices in microservice cluster 700-1 do not appear in microservice cluster 700-2, and vice versa, and changes to microservices in microservice cluster 700-1 do not directly affect microservices in microservice cluster 700-2). Thus, the test cases for microservice clusters 700-1 and 700-2 may be executed in parallel.

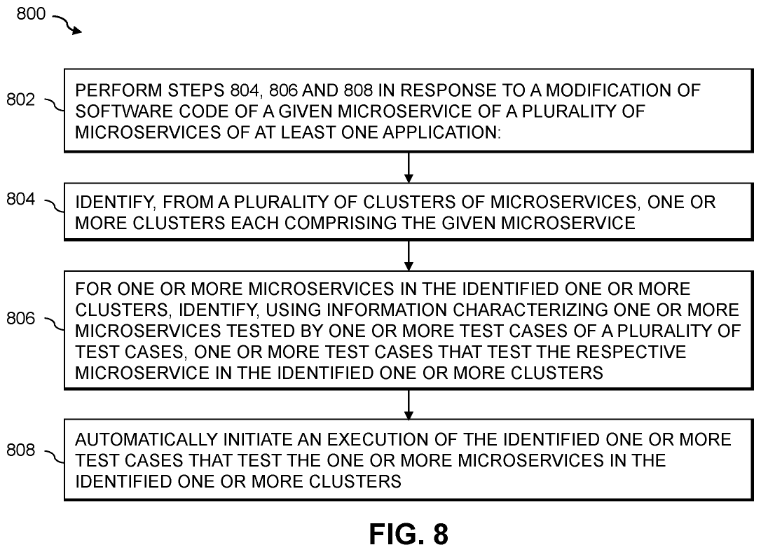

FIG. 8 is a flow chart illustrating an exemplary implementation of a process 800 for automated identification of software application test cases for testing microservices in an illustrative embodiment. In the example of FIG. 8, steps 804, 806 and 808 are performed in response to a modification, detected in step 802, of software code of a given microservice of a plurality of microservices of at least one application. In step 804, one or more clusters, from a plurality of clusters of microservices, are identified that each comprise the given microservice.

For one or more microservices in the identified one or more clusters, one or more test cases are identified in step 806 that test the respective microservice in the identified one or more clusters, using information characterizing one or more microservices tested by one or more test cases of a plurality of test cases. An execution of the identified one or more test cases that test the one or more microservices in the identified one or more clusters is automatically initiated in step 808.

In some embodiments, the information characterizing the one or more microservices tested by the one or more test cases of the plurality of test cases is obtained by performing a test coverage analysis for the plurality of test cases. The information characterizing the one or more microservices tested by a given test case may be stored as a value in a key-value pair associated with the given test case. The one or more test case failures may be reported.

In one or more embodiments, the plurality of clusters of microservices is generated using a feature vector representation of respective microservices of the plurality of microservices, wherein the feature vector representation of a given microservice comprises a binary value for each of a plurality of microservice endpoints indicating whether the given microservice uses the respective microservice endpoint. The binary value for each microservice endpoint indicating whether the given microservice uses the respective microservice endpoint is populated using a first set of input endpoints and a second set of output endpoints for the given microservice, wherein the first and the second sets are obtained based at least in part on a static code analysis of the given microservice.

In at least one embodiment, the execution of one or more test cases associated with a first cluster is performed in parallel with one or more test cases associated with a second cluster that does not overlap with the first cluster.

The particular processing operations and other network functionality described in conjunction with FIGS. 3 through 6 and 8, for example, are presented by way of illustrative example only, and should not be construed as limiting the scope of the disclosure in any way. Alternative embodiments can use other types of processing operations for automated identification of software application test cases for testing microservices. For example, the ordering of the process steps may be varied in other embodiments, or certain steps may be performed concurrently with one another rather than serially. In one aspect, the process can skip one or more of the actions. In other aspects, one or more of the actions are performed simultaneously. In some aspects, additional actions can be performed.

The disclosed techniques for automated identification of software application test cases for testing microservices can be employed, for example, to improve the comprehensiveness of the testing process and/or to reduce the time required for testing.

One or more embodiments of the disclosure provide improved methods, apparatus and computer program products for automated identification of software application test cases for testing microservices. The foregoing applications and associated embodiments should be considered as illustrative only, and numerous other embodiments can be configured using the techniques disclosed herein, in a wide variety of different applications.

It should also be understood that the disclosed automated test case identification techniques, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for automated identification of software application test cases for testing microservices may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services can be offered to cloud infrastructure tenants or other system users as a PaaS offering, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based automated test case identification engine, or portions thereof, are illustratively implemented for use by tenants of such a multi-tenant environment.

Cloud infrastructure as disclosed herein can include one or more cloud-based systems. Virtual machines provided in such systems can be used to implement at least portions of a cloud-based automated test case identification platform in illustrative embodiments. The cloud-based systems can include one or more object stores.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

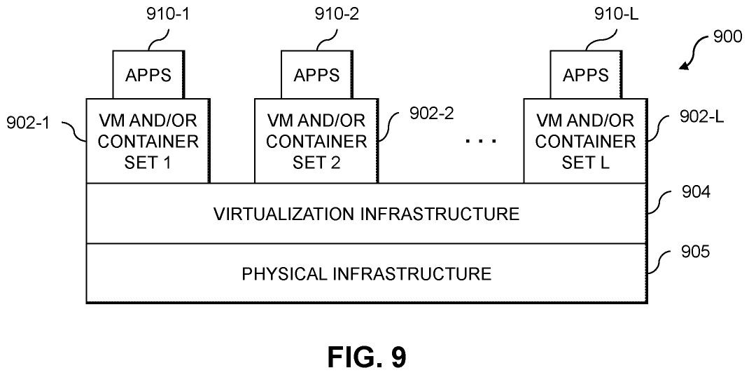

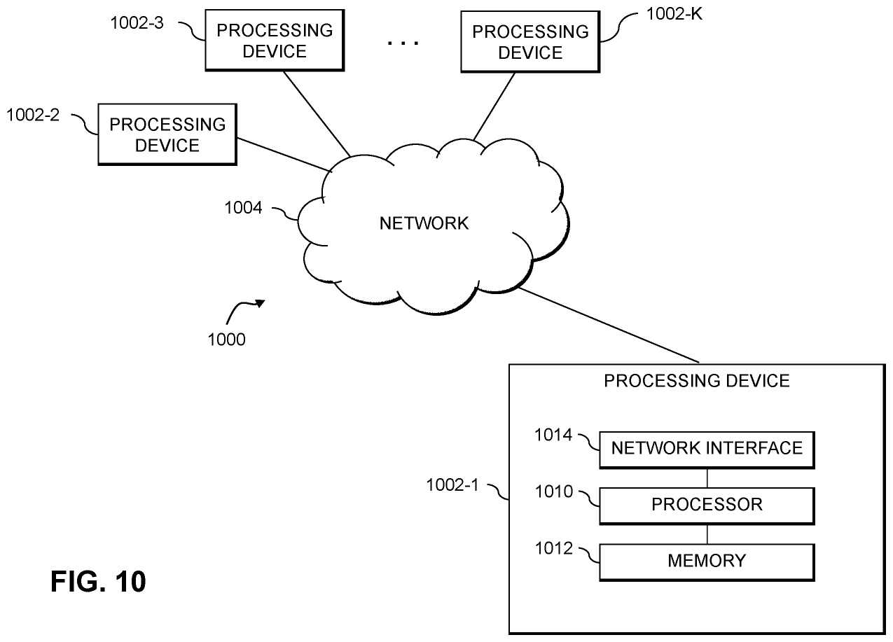

Illustrative embodiments of processing platforms will now be described in greater detail with reference to FIGS. 9 and 10. These platforms may also be used to implement at least portions of other information processing systems in other embodiments.

FIG. 9 shows an example processing platform comprising cloud infrastructure 900. The cloud infrastructure 900 comprises a combination of physical and virtual processing resources that may be utilized to implement at least a portion of the information processing system 100. The cloud infrastructure 900 comprises multiple virtual machines (VMs) and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups of a Linux operating system or other type of operating system.

The cloud infrastructure 900 further comprises sets of applications 910-1, 910-2, . . . 910-L running on respective ones of the VMs/container sets 902-1, 902-2, . . . 902-L under the control of the virtualization infrastructure 904. The VMs/container sets 902 may comprise respective VMs, respective sets of one or more containers, or respective sets of one or more containers running in VMs.

In some implementations of the FIG. 9 embodiment, the VMs/container sets 902 comprise respective VMs implemented using virtualization infrastructure 904 that comprises at least one hypervisor. Such implementations can provide automated test case identification functionality of the type described above for one or more processes running on a given one of the VMs. For example, each of the VMs can implement automated test case identification control logic and associated microservice clustering functionality for one or more processes running on that particular VM.

An example of a hypervisor platform that may be used to implement a hypervisor within the virtualization infrastructure 904 is the VMware® vSphere® which may have an associated virtual infrastructure management system such as the VMware® vCenter™. The underlying physical machines may comprise one or more distributed processing platforms that include one or more storage systems.

In other implementations of the FIG. 9 embodiment, the VMs/container sets 902 comprise respective containers implemented using virtualization infrastructure 904 that provides operating system level virtualization functionality, such as support for Docker containers running on bare metal hosts, or Docker containers running on VMs. The containers are illustratively implemented using respective kernel control groups of the operating system. Such implementations can provide automated test case identification functionality of the type described above for one or more processes running on different ones of the containers. For example, a container host device supporting multiple containers of one or more container sets can implement one or more instances of automated test case identification control logic and associated microservice clustering functionality.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 900 shown in FIG. 9 may represent at least a portion of one processing platform. Another example of such a processing platform is processing platform 1000 shown in FIG. 10.

The processing platform 1000 in this embodiment comprises at least a portion of the given system and includes a plurality of processing devices, denoted 1002-1, 1002-2, 1002-3, . . . 1002-K, which communicate with one another over a network 1004. The network 1004 may comprise any type of network, such as a WAN, a LAN, a satellite network, a telephone or cable network, a cellular network, a wireless network such as WiFi or WiMAX, or various portions or combinations of these and other types of networks.

The processing device 1002-1 in the processing platform 1000 comprises a processor 1010 coupled to a memory 1012. The processor 1010 may comprise a microprocessor, a microcontroller, an ASIC, an FPGA or other type of processing circuitry, as well as portions or combinations of such circuitry elements, and the memory 1012, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 9 or 10, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
performing the following steps, in response to a modification of software code of a given microservice of a plurality of microservices of at least one application:
identifying, from a plurality of clusters of microservices, one or more clusters each comprising the given microservice;
for one or more microservices in the identified one or more clusters, identifying, using information characterizing one or more microservices tested by one or more test cases of a plurality of test cases, one or more test cases that test the respective microservice in the identified one or more clusters; and
automatically initiating an execution of the identified one or more test cases that test the one or more microservices in the identified one or more clusters;
wherein the method is performed by at least one processing device comprising a processor coupled to a memory.

2. The method of claim 1, wherein the information characterizing the one or more microservices tested by the one or more test cases of the plurality of test cases is obtained by performing a test coverage analysis for the plurality of test cases.

3. The method of claim 2, wherein the information characterizing the one or more microservices tested by a given test case is stored as a value in a key-value pair associated with the given test case.

4. The method of claim 1, further comprising reporting one or more test case failures.

5. The method of claim 1, wherein the plurality of clusters of microservices is generated using a feature vector representation of respective microservices of the plurality of microservices, wherein the feature vector representation of a given microservice comprises a binary value for each of a plurality of microservice endpoints indicating whether the given microservice uses the respective microservice endpoint.

6. The method of claim 5, wherein the binary value for each microservice endpoint indicating whether the given microservice uses the respective microservice endpoint is populated using identifiers of a first set of input endpoints and identifiers of a second set of output endpoints for the given microservice, wherein the identifiers of the first and the second sets are obtained based at least in part on a static code analysis of the given microservice.

7. The method of claim 1, wherein the execution of one or more test cases associated with a first cluster is performed in parallel with one or more test cases associated with a second cluster that does not overlap with the first cluster.

8. An apparatus comprising:
at least one processing given device comprising a processor coupled to a memory;
the at least one processing given device being configured to implement the following steps, in response to a modification of software code of a given microservice of a plurality of microservices of at least one application:
identifying, from a plurality of clusters of microservices, one or more clusters each comprising the given microservice;
for one or more microservices in the identified one or more clusters, identifying, using information characterizing one or more microservices tested by one or more test cases of a plurality of test cases, one or more test cases that test the respective microservice in the identified one or more clusters; and
automatically initiating an execution of the identified one or more test cases that test the one or more microservices in the identified one or more clusters.

9. The apparatus of claim 8, wherein the information characterizing the one or more microservices tested by the one or more test cases of the plurality of test cases is obtained by performing a test coverage analysis for the plurality of test cases.

10. The apparatus of claim 9, wherein the information characterizing the one or more microservices tested by a given test case is stored as a value in a key-value pair associated with the given test case.

11. The apparatus of claim 8, further comprising reporting one or more test case failures.

12. The apparatus of claim 8, wherein the plurality of clusters of microservices is generated using a feature vector representation of respective microservices of the plurality of microservices, wherein the feature vector representation of a given microservice comprises a binary value for each of a plurality of microservice endpoints indicating whether the given microservice uses the respective microservice endpoint.

13. The apparatus of claim 12, wherein the binary value for each microservice endpoint indicating whether the given microservice uses the respective microservice endpoint is populated using identifiers of a first set of input endpoints and identifiers of a second set of output endpoints for the given microservice, wherein the identifiers of the first and the second sets are obtained based at least in part on a static code analysis of the given microservice.

14. The apparatus of claim 8, wherein the execution of one or more test cases associated with a first cluster is performed in parallel with one or more test cases associated with a second cluster that does not overlap with the first cluster.

15. A non-transitory processor-readable storage medium having stored therein program code of one or more software programs, wherein the program code when executed by at least one processing given device causes the at least one processing given device to perform the following steps, in response to a modification of software code of a given microservice of a plurality of microservices of at least one application:
identifying, from a plurality of clusters of microservices, one or more clusters each comprising the given microservice;
for one or more microservices in the identified one or more clusters, identifying, using information characterizing one or more microservices tested by one or more test cases of a plurality of test cases, one or more test cases that test the respective microservice in the identified one or more clusters; and
automatically initiating an execution of the identified one or more test cases that test the one or more microservices in the identified one or more clusters.

16. The non-transitory processor-readable storage medium of claim 15, wherein the information characterizing the one or more microservices tested by the one or more test cases of the plurality of test cases is obtained by performing a test coverage analysis for the plurality of test cases and wherein the information characterizing the one or more microservices tested by a given test case is stored as a value in a key-value pair associated with the given test case.

17. The non-transitory processor-readable storage medium of claim 15, further comprising reporting one or more test case failures.

18. The non-transitory processor-readable storage medium of claim 15, wherein the plurality of clusters of microservices is generated using a feature vector representation of respective microservices of the plurality of microservices, wherein the feature vector representation of a given microservice comprises a binary value for each of a plurality of microservice endpoints indicating whether the given microservice uses the respective microservice endpoint.

19. The non-transitory processor-readable storage medium of claim 18, wherein the binary value for each microservice endpoint indicating whether the given microservice uses the respective microservice endpoint is populated using identifiers of a first set of input endpoints and identifiers of a second set of output endpoints for the given microservice, wherein the identifiers of the first and the second sets are obtained based at least in part on a static code analysis of the given microservice.

20. The non-transitory processor-readable storage medium of claim 15, wherein the execution of one or more test cases associated with a first cluster is performed in parallel with one or more test cases associated with a second cluster that does not overlap with the first cluster.
